(19) United States
(12) Patent Application Publication
(10) Pub. No.: US 2008/0094330 A1
(43) Pub. Date: Apr. 24, 2008

(54) Structure for storing overdrive image data and a method thereof

(75) Inventors: Wei-Yeh Sun, Taipei City (TW); Chih-Chung Lu, Taipei County (TW)

Correspondence Address: BIRCH STEWART KOLASCH & BIRCH, PO BOX 747, FALLS CHURCH, VA, 22040-0747, US

(73) Assignee: Sitronix Technology Corp.

(21) Appl. No.: 11/582,308

(22) Filed: Oct. 18, 2006

(51) Int. Cl. G09G 3/36

(52) U.S. Cl. 345/88

(57) ABSTRACT

The present invention discloses a structure for storing overdrive image data and a method thereof, which divide image data into non-video data and video data and respectively store them in a non-video data storage region and a video data storage region of a memory unit, wherein the RGB data of the non-video data is directly stored in the video data storage region; the RGB data of the video data is transformed into YCbCr data; via checking a lookup table, the RGB data of the present video data is compared with the RGB data of the preceding frame to obtain overdrive YCbCr data; the YCbCr data and the overdrive YCbCr data are sampled, compressed and synthesized according to a video data compression standard and then stored in the video data storage region. Thereby, the memory space required by the overdrive technology can be reduced.

### FIELD OF THE INVENTION

The present invention relates to a technology for storing image data of a display, particularly to a structure for storing overdrive image data and a method thereof, whereby the required memory space can be reduced.

### BACKGROUND OF THE INVENTION

As LCD (Liquid Crystal Display) has the advantages of slimness, compactness and lightweight and consumes less power than the conventional CRT (Cathode Ray Tube), LCD has been gradually replacing CRT recently.

Liquid crystal is an organic compound having properties between those of a liquid and those of a solid crystal. The color or transparency of liquid crystal is changed by the variation of temperature or applied voltage. A conventional liquid crystal display (LCD) comprises: a liquid crystal panel and a driver circuit connected to the liquid crystal display, wherein the driver circuit includes a gray-level voltage generating circuit.

A liquid crystal display comprises: a plurality of gate lines and a plurality of data lines vertical to the gate lines. Each pixel of a liquid crystal display includes: a TFT (Thin Film Transistor), a storage capacitor and a liquid crystal capacitor. Each pixel has three subpixels respectively corresponding to RGB (i.e. trichromatic or three-primary-color) elements of a color filter. The combination of RGB color lights not only can present colored pictures but also can present pure red, green, and blue colors and gray levels. In liquid crystal display, TFT functions as a switch; the TFT gate is electrically connected with a gate line and controlled by a gate driving circuit; the TFT source is electrically connected with a data line and controlled by a source driving circuit. The gray-level voltage generating circuit is connected to the source driving circuit and generates a gray-level voltage or a gray-level reference voltage for a liquid crystal driving voltage.

In the operation of a liquid crystal display, the gate driving circuit sequentially scans each column of pixels; after the gray-level voltage generating circuit outputs a gray-level reference voltage, the source driving circuit generates a liquid crystal driving voltage according to RGB timing data and applies the generated liquid crystal driving voltage to the display panel in each scanning activity.

The current trend is to fabricate high-speed LCD. At present, the LCD driving speed is promoted via increasing the charging rate of the storage capacitor and the liquid crystal capacitor. If the voltage applied by the source driving circuit is high enough, the storage capacitor and the liquid crystal capacitor will be charged rapidly, and the LCD driving speed is thus promoted.

Refer to FIG. 1 a diagram schematically showing the input gray-level voltage and the output overdrive gray-level voltage. Based on the input gray level 1 of the original image data and the gray level of the preceding frame, a lookup table is checked or a conversion operation is performed to obtain an overdrive gray level 2, and the overdrive gray level 2 is output to the display. Via increasing the gray level of image data, the overdrive technology shortens TFT response time and accelerates liquid crystal inversion and makes pictures move smoother. In the example shown in FIG. 1, the gray level 1 of the original image data enables the display to reach brightness B21 in 16.6 ms; however, the overdrive gray level 2 can enable the display to reach brightness B31 in 16.6 ms.

To store the original image data and the overdrive image data, the memory space required by the LCD driver adopting the overdrive technology is double the memory space required by the LCD driver without the overdrive technology. In a general mobile phone, with the non-synchronicity of image data inputting and pixel scanning, an extraneous memory is added to the display driver to store the overdrive image data; via increasing the gray level of the original image data, the response time of pixels is shortened, and the pictures can move smoother.

In the abovementioned technology, an extraneous memory is added to the driver circuit to increase memory capacity. However, such a method requires a larger space to accommodate the driver circuit and increases the fabrication cost.

### SUMMARY OF THE INVENTION

To solve the abovementioned problems, the present invention transforms the trichromatic data of the image frame into YCbCr data and transforms overdrive trichromatic data into overdrive YCbCr data and samples, compresses and synthesizes the abovementioned two YCbCr data according to a video data compression standard. Thereby, the present invention can reduce the memory space required by the display driver controller adopting the overdrive technology. Thus, the memory cost is reduced.

To achieve the abovementioned objectives, the present invention proposes a method for storing overdrive image data of a display driver controller, which divides image data into non-video data and video data and respectively stores them in a non-video data storage region and a video data storage region inside a memory unit, wherein the trichromatic data of the non-video data is directly stored in the video data storage region; the trichromatic data of the video data is transformed into YCbCr data; the trichromatic data of the video data is compared with the trichromatic data of the preceding frame via checking a lookup table to obtain overdrive YCbCr data; the YCbCr data and the overdrive YCbCr data are sampled, compressed and synthesized according to a video data compression standard and then stored in the video data storage region.

Y denotes luminance; Cb and Cr denote chrominances. In the present invention, Y, Cb, and Cr are sampled according to a sampling rate and then compressed and stored in a memory module. Thereby, the capacity of the memory unit required by the driver controller can be reduced.

The method of the present invention is realized via changing the memory structure of the display driver controller. The present invention further proposes a structure for storing overdrive image data. The structure of the present invention comprises: a memory unit, a first multiplexer, a first transformation unit, a second transformation unit, and a data encoding unit. The memory unit includes a non-video data storage region and a video data storage region. The first multiplexer has two input ends; one input end receives non-video RGB (trichromatic) data of image frames, and the first multiplexer outputs the data to the non-video data storage region. The first transformation unit receives the video RGB (trichromatic) data of the present image frame (frame N) and transforms the RGB data into YCbCr data. Via checking a lookup table, the second transformation unit compares the video RGB data of the present frame (frame N) and the video RGB data of the preceding frame (frame N-1) to obtain overdrive YCbCr data (Y′Cb′Cr′). The data encoding unit receives the YCbCr data output by the first transformation unit and the overdrive YCbCr data output by the second transformation unit and samples, compresses and synthesizes the YCbCr data and the overdrive YCbCr data according to a video data compression standard, wherein the compression sampling is performed according to one of the following sampling rates: Y:Cb:Cr=4:2:2, Y:Cb:Cr=4:2:0, and Y:Cb:Cr=4:1:1. The first multiplexer receives the synthesized data with the other input end and sends the synthesized data to the video data storage region.

The video RGB data of the preceding frame (frame N-1) is obtained via that the YCbCr data and the overdrive YCbCr data of the preceding image frame stored in the video data storage region are decompressed by a data decoding unit according to the original video data compression standard and transformed by a third transformation unit into the video RGB data of the preceding image frame. The transformed video RGB data of the preceding image frame is then sent to the lookup table.

One input end of a second multiplexer receives the data stored in the non-video data storage region. A decompression transformation unit transforms the data stored in the video data storage region into RGB data and sends the RGB data to the other input end of the second multiplexer; and the second multiplexer sends the non-video data and the video data to a display element.

### BRIEF DESCRIPTION OF THE DRAWINGS

FIG. 1 is a diagram schematically showing the input gray-level voltage and the output overdrive gray-level voltage.

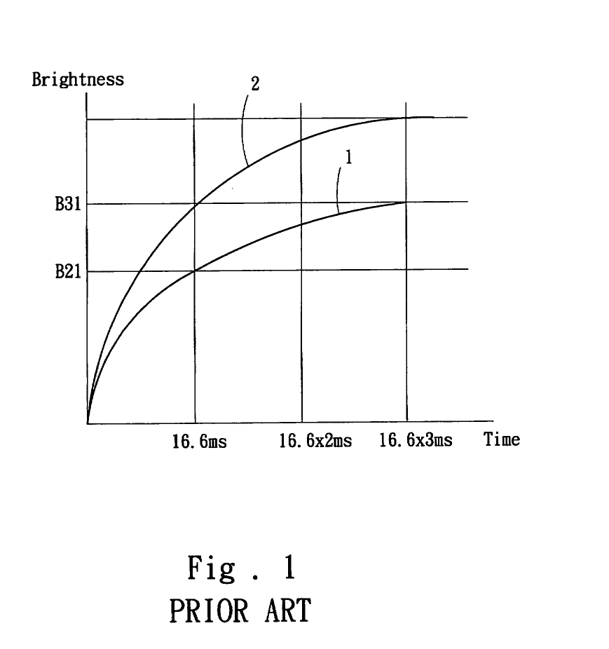

FIG. 2 is a diagram schematically showing the structure for storing overdrive image data according to the present invention.

FIG. 3 is a diagram schematically showing that image data is divided into non-video data and video data.

FIG. 4 is a diagram schematically showing the storage of video data according to the present invention.

### DETAILED DESCRIPTION OF THE PREFERRED EMBODIMENTS

The technical contents of the present invention are to be described in detail in cooperation with the drawings below.

Different light wavelengths generate the colors sensed by humans. It is found in experiment: Humans are most sensitive to three specific wavelengths, and appropriately adjusting the intensities of those three light components can make humans sense almost all colors. The three light components, i.e. red light, green light and blue light, are the so-called three primary colors (RGB). All colored TV or screens have light-emitting devices to generate the three primary colors. As almost all colors can be generated via mixing the three primary colors, the digital RGB values are used to denote colors in computers. When each of the three primary colors is designated with 8 bits, each color can have 256 levels of brightness (0-255). The combination of three digital RGB values has more than sixteen million variations, and that is the well-known 24-bit true color.

In YCbCr data, Y denotes the gray level or the luminance transformed from colors, and the conversion equation is based on the sensitivities of human eyes to three primary colors. The higher the sensitivity to a color, the greater the coefficient of the color in the conversion equation. The sensitivities to RGB are G (0.587), R (0.299) and B (0.114) in sequence. Therefore, the conversion equation from RGB to YCbCr can be expressed by

Y=0.299R+0.587G+0.114B

Cb=−0.168R−0.331G−0.499B

Cr=0.500R−0.419G−0.081B

### The conversion equation from YCbCr to RGB is expressed by

R=Y+1.3710(Cr-128)

G=Y−0.3441(Cb-128)−0.7141(Cr-128)

B=Y+1.6914(Cb-128)

Human eyes are more sensitive to low-frequency data than to high-frequency data. Also, human eyes are much more sensitive to luminance variation than to color variation. In general, the display device processes only gray-level and true-color images. A true-color image is formed of the three components of YCbCr. A gray-level image has none color but only luminance; therefore, a gray-level image has only one component Y. In YCbCr data, Y denoting luminance is more important than Cb/Cr denoting chrominance.

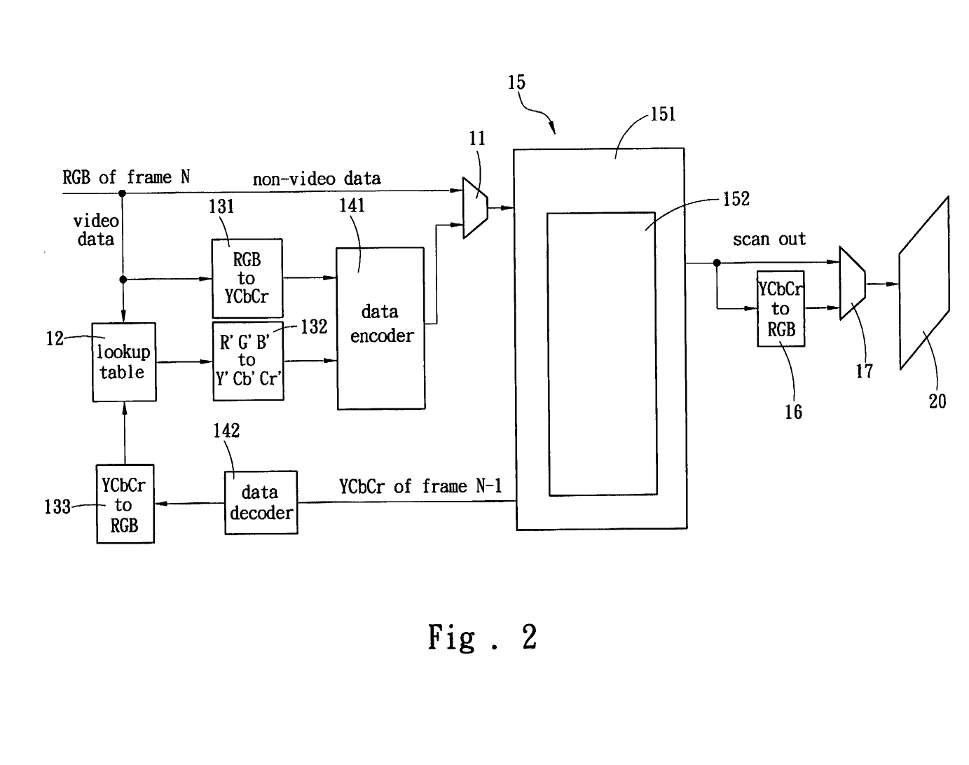

The present invention pertains to a structure for storing overdrive image data, which is installed in the driver controller of a display. Refer to FIG. 2 a diagram schematically showing the structure for storing overdrive image data according to the present invention. The structure of the present invention comprises: a memory unit 15, a first multiplexer 11, a first transformation unit 131, a second transformation unit 132 and a data encoding unit 141. The memory unit 15 is divided into a non-video data storage region 151 and a video data storage region 152. The first multiplexer 11 has two input ends; one input end receives trichromatic non-video data of the present image frame (frame N), and the first multiplexer 11 outputs the data to the non-video data storage region 151; the other input end receives transformed and synthesized video data; and the first multiplexer 11 outputs the video data to the video data storage region 152 of the memory unit 15.

Before being stored, the video data is firstly sent to the first transformation unit 131. The first transformation unit 131 receives the video RGB (trichromatic) data of the present image frame (frame N) and transforms the RGB data into YCbCr data. Via checking a lookup table 12, the second transformation unit 132 compares the original video RGB data of the present frame and the original video RGB data of the preceding frame to transform the overdrive RGB data R′G′B′ into overdrive YCbCr data Y′Cb′Cr′. The data encoding unit 141 receives the YCbCr data output by the first transformation unit 131 and the overdrive YCbCr data Y′Cb′Cr′ output by the second transformation unit 132 and samples, compresses and synthesizes the YCbCr data and the overdrive YCbCr data Y′Cb′Cr′ according a video data compression standard of MPEG (Motion Pictures Expert Group), wherein the compression sampling is performed according to one of the following sampling rates: Y:Cb:Cr=4:2:2, Y:Cb:Cr=4:2:0, and Y:Cb:Cr=4:1:1. The first multiplexer 11 receives the synthesized data with the other input end and sends the synthesized data to the video data storage region 152.

The video RGB data of the preceding frame (frame N-1) is obtained via that the original YCbCr data of the preceding image frame stored in the video data storage region 152 is decompressed by a data decoding unit 142 according to the original video data compression standard and then transformed by a third transformation unit 133 into the video RGB data of the preceding image frame.

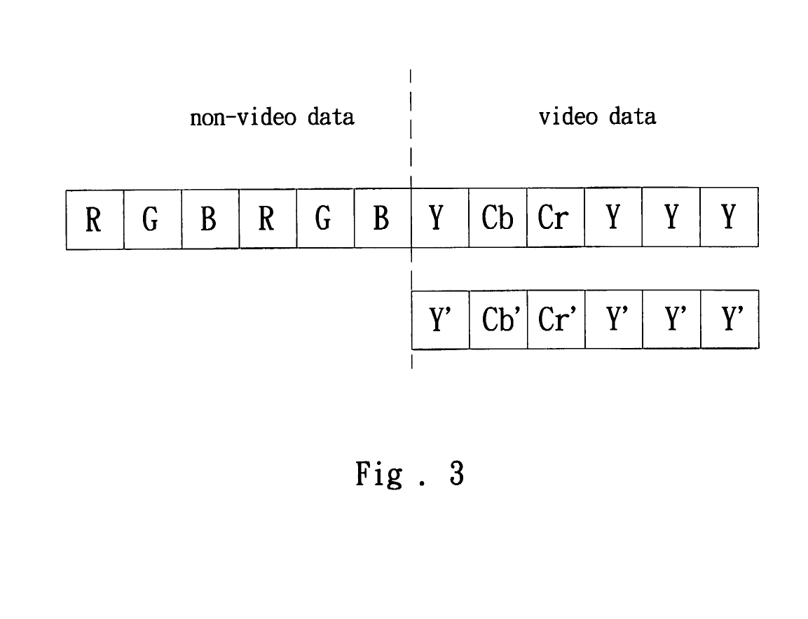

Refer to FIG. 3 a diagram schematically showing that image data is divided into non-video data and video data. The non-video data storage region 151 of the memory unit 15 is used to store the non-video trichromatic data R, G and B of the original image frame. The video data storage region 152 of the memory unit 15 is used to store the sampled and compressed YCbCr data of the present frame and the sampled and compressed overdrive YCbCr data Y′Cb′Cr′. If the compression is performed according to the sampling rate Y:Cb:Cr=4:1:1 (4:2:0), the set of YCbCr data, whose CbCr data is jointly used by four Y data, will be stored in the front, and the set of Y′Cb′Cr′ data, whose Cb′Cr′ data is jointly used by four Y′ data, will be stored therebehind.

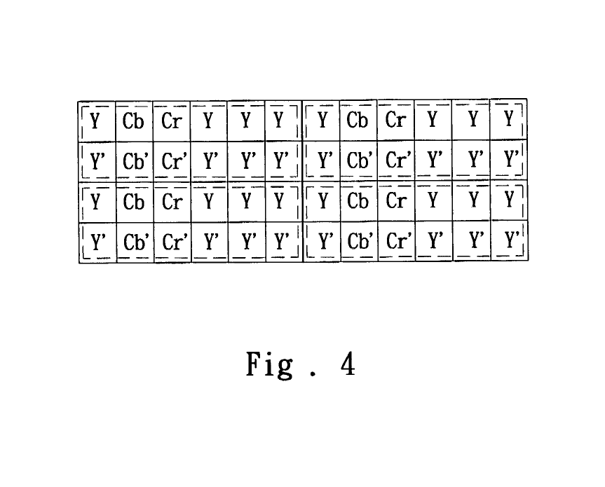

Refer to FIG. 4 a diagram schematically showing the storage of video data according to the present invention, wherein 4×4 pixels of a display is used as the exemplification. After the original video data of the image frames is sampled and compressed according to the sampling rate Y:Cb:Cr=4:1:1 (4:2:0), four sets of sampled and compressed original YCbCr data and four sets of sampled and compressed overdrive YCbCr data Y′Cb′Cr′ are stored in the video data storage region 152. Therefore, there are not only four sets of sampled and compressed original YCbCr data but also four sets of sampled and compressed overdrive YCbCr data Y′Cb′Cr′ in the video data storage region 152. Via merely sampling and compressing the original YCbCr data and the overdrive YCbCr data Y′Cb′Cr′, the gray level of the video data is increased. Thereby, the response of TFT and the inversion of liquid crystal are accelerated, and the pictures move smoother. Further, the memory space required by the display driver controller adopting the overdrive technology is thus reduced, and the memory cost also decreases.

One input end of a second multiplexer 17 receives the RGB data stored in the non-video data storage region 151. A decompression transformation unit 16 transforms the YCbCr data stored in the video data storage region 152 into RGB data and sends the RGB data to the other input end of the second multiplexer 17; and the second multiplexer 17 sends the non-video data and the video data to a display element 20.

The present invention also proposes a method for storing overdrive image data, which divides image data into non-video data and video data and respectively stores them in a non-video data storage region 151 and a video data storage region 152 of a memory unit 15, wherein the RGB data of the non-video data is directly stored in the non-video data storage region 151; the RGB data of the video data is transformed into YCbCr data; via checking a lookup table 12, the RGB data of the video data is compared with the RGB data of the preceding frame to obtain overdrive YCbCr data Y′Cb′Cr′; the YCbCr data and the overdrive YCbCr data Y′Cb′Cr′ are sampled, compressed and synthesized according to a video data compression standard and then stored in the video data storage region 152.

In the example of 4×4 sets of RGB data in the conventional overdrive technology, the memory not only uses 16×3=48 bits to stores the original RGB data but also has to spend 16×3=48 bits on storing the overdrive R′G′B′ data. Therefore, when a display adopts the overdrive technology, double memory space, totally amounting to 96 bits, is needed to store the original image data and the overdrive image data.

In the present invention, RGB data is firstly transformed into YCbCr data; then, the YCbCr data is sampled and compressed according to one of the following sampling rates: Y:Cb:Cr=4:2:2, Y:Cb:Cr=4:2:0, and Y:Cb:Cr=4:1:1. In the example of Y:Cb:Cr=4:1:1 (4:2:0), one set of Cb and Cr data is jointly used by four Y data. Similarly, one set of Cb′ and Cr′ data is jointly used by four Y′ data for. Therefore, in the present invention, the display adopting the overdrive mode only needs 48 bits—the same memory space as that the display without the overdrive mode needs. Therefore, the present invention can save half the memory space used by the conventional overdrive technology.

In summary, the present invention transforms the original RGB video data and the overdrive RGB video data of image frames into YCbCr data and samples, compresses both YCbCr data according to a video data compression standard and then stores the sampled and compressed YCbCr data in the memory of a display driver controller. Thereby, the memory space required by the overdrive mode can be reduced, and the original memory is enough to store the image data of the overdrive mode. Thus, the memory cost decreases.

Those described above are the preferred embodiments to exemplify the present invention. However, it is not intended to limit the scope of the present invention. Any equivalent modification and variation according to the spirit of the present invention is to be also included within the scope of the present invention.

What is claimed is:

1. A structure for storing overdrive image data, installed in the driver controller of a display, and comprising:
a memory unit, further comprising a non-video data storage region and a video data storage region;
a first multiplexer, having two input ends, receives non-video RGB data of image frames with one said input end, and outputting said non-video RGB data to said non-video data storage region;
a first transformation unit, receiving video RGB data of image lo frames, and transforming said video RGB data into YCbCr data;
a second transformation unit, checking a lookup table to compare the video RGB data of the present image frame with the video RGB data of the preceding image frame to obtain overdrive YCbCr data; and
a data encoding unit, receiving said YCbCr data output by said first transformation unit and said overdrive YCbCr data output by said second transformation unit, sampling, compressing and synthesizing said YCbCr data and said overdrive YCbCr data according to a video data compression standard, and sending the synthesized data to the other said input end of said first multiplexer, wherein said first multiplexer further sends said synthesized data to said video data storage region.

2. The structure for storing overdrive image data according to claim 1, wherein said video RGB data of the preceding image frame is obtained via that the original YCbCr data of the preceding image frame stored in said video data storage region is decompressed by a data decoding unit according to said video data compression standard and transformed by a third transformation unit into said video RGB data of the preceding image frame.

3. The structure for storing overdrive image data according to claim 1, wherein one input end of a second multiplexer receives the data stored in said non-video data storage region; a decompression transformation unit decompresses the data stored in said video data storage region into RGB data and sends said RGB data to the other input end of said second multiplexer; and said second multiplexer sends the non-video data and the video data to a display element.

4. The structure for storing overdrive image data according to claim 1, wherein said sampling and compressing is performed according to one of the following sampling rates: Y:Cb:Cr=4:2:2, Y:Cb:Cr=4:2:0, and Y:Cb:Cr=4:1:1.

5. A method for storing overdrive image data, applying to the driver controller of a display, and comprising the following steps:
dividing image data into non-video data and video data, and respectively storing said non-video data and said video data in a non-video data storage region and a video data storage region of a memory unit, wherein the RGB data of said non-video data is directly stored in said video data storage region;
transforming the RGB data of said video data into YCbCr data; checking a lookup table to compare the RGB data of said video data with the RGB data of the preceding image frame; to obtain overdrive YCbCr data; sampling, compressing and synthesizing said YCbCr data and said overdrive YCbCr data according to a video data compression standard, and storing the synthesized data to said video data storage region.

6. The method for storing overdrive image data according to claim 5, wherein said sampling and compressing is performed according to one of the following sampling rates: Y:Cb:Cr=4:2:2, Y:Cb:Cr=4:2:0, and Y:Cb:Cr=4:1:1.
